(19) United States
(12) Patent Application Publication
(10) Pub. No.: US 2011/0072947 A1
(43) Pub. Date: Mar. 31, 2011

(54) PNEUMATIC PUNCH DEVICE

(76) Inventor: John Prout, Salt Lake City, UT (US)

(21) Appl. No.: 12/569,950

(22) Filed: Sep. 30, 2009

(51) Int. Cl. B26D 5/12

(52) U.S. Cl. 83/639.4; 83/639.1

(57) ABSTRACT

In one exemplary embodiment of the invention, the device includes an outer housing. The outer housing includes an internal cavity, at least one opening and a distal end. The distal end is configured to be near the construction material during use. The device also includes an internal piston that includes a tip. The internal piston is received within the internal cavity and is configured for reciprocal motion within the outer housing. The device further includes a handle coupled to the outer housing and a trigger mechanism. The trigger mechanism is configured to release pressurized gas within a blast chamber. The pressurized gas drives the internal piston through the opening in the outer housing to produce a hole in the construction material.

### BACKGROUND OF THE INVENTION

1. The Field of the Invention

The present invention generally relates to construction tools. More particularly, the present invention relates to a device for creating holes in construction materials.

2. The Relevant Technology

Metal decking is an important component in modern construction. It may be used to provide roofing or flooring in structures such as airports, universities, hospitals, and other large commercial buildings. Metal decking is often used in conjunction with concrete to provide a floor base. In fact, metal decking can be used to form multiple levels within a building, even when not used in conjunction with concrete. Additionally, the use of concrete and metal decking is spreading from large commercial settings to a more broad use including smaller buildings and even single-family homes.

After metal decking has been laid, there is often a need to produce holes in the decking. For example, plumbing, duct work, wiring or other material may need to be installed after the metal decking is in place. However, it can be difficult to make holes in the decking to allow access for these components. The current method for producing holes in metal decking is physically taxing and labor-intensive. To produce the desired holes, a device comprising a long external metal guide is held by one worker and an internal metal rod is moved up and down through the external guide by a second worker. In many cases, the internal rod is driven into the metal decking using a sledge hammer or through other means involving manual labor. The internal rod has a shaped point at the bottom end that is driven into the metal decking in order to produce a desired hole of the proper shape and size in the decking. The internal rod may have to be driven into the metal decking repeatedly before a hole is punched through the metal decking.

The above described method of punching holes in metal decking may be physically strenuous, and must be repeated for every hole made in the metal decking. Additionally, it may require the time and attention of two workers. This may be labor-intensive and very taxing on a construction crew. Additionally, there is potential for serious injury or damage to the structure. Thus, there is a need in the art for an improved means for punching holes in metal decking that would only require a single worker to operate. Also, there is a need for a less physically demanding means for producing holes in metal decking.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In light of the aforementioned needs, the present invention provides an improved means for producing holes in construction material via a pneumatic punching device. The present invention is operable by a single individual, and requires minimal physical effort in comparison to the current methods of producing holes within construction material.

In one exemplary embodiment of the invention, the device includes an outer housing. The outer housing includes an internal cavity, at least one opening and a distal end. The distal end is configured to be near the construction material during use. The device also includes an internal piston that includes a tip. The internal piston is received at least partially within the internal cavity and is configured for reciprocal motion within the outer housing. The device further includes a handle coupled to the outer housing and a trigger mechanism. The trigger mechanism is configured to release pressurized gas within a blast chamber. The pressurized gas drives the internal piston through the opening in the outer housing to produce a hole in the construction material.

In another exemplary embodiment of the present invention, the device includes an outer housing. The outer housing includes an internal cavity and at least one opening. The device also includes an internal piston with a tip. The internal piston is received at least partially within the internal cavity of the outer housing and the internal piston includes a longitudinal axis which is generally parallel to a longitudinal axis of the outer housing. The device further includes means for retracting the internal piston and means for regulating the motion of the internal piston within a desired range. The device also includes a handle coupled to the outer housing and means for driving the internal piston.

In another exemplary embodiment of the present invention, the device includes an outer housing. The outer housing includes an internal cavity, at least one opening, a first housing stop and a second housing stop. The device also includes an internal piston. The internal piston is housed at least partially within the internal cavity and is configured for reciprocal motion within the outer housing. The internal piston includes a first end, a second end with a tip opposite the first end and a first piston stop. The device further includes a means for retracting the internal piston. The means for retracting the piston retracts at least a portion of the internal piston through the opening into the internal cavity. The first piston stop is disposed between the first housing stop and second housing stop to work cooperatively with the first housing stop and second housing stop to regulate the reciprocal motion of the internal piston. The device also includes a handle which is coupled to the outer housing and a trigger mechanism attached to the handle. The device further includes a blast chamber. The first end of the internal piston is seated within the blast chamber and is able to move reciprocally therein. The device also includes a mechanism for driving the internal piston so the tip can punch a hole in the construction material. The mechanism for driving the internal piston can include a combustible powder, a gas compressor, a cartridge filled with compressed carbon dioxide, combinations thereof, and the like. For instance, a combustible powder can deposited within the blast chamber. The combustible powder can be detonated within the blast chamber when the trigger mechanism is actuated, driving the internal piston through the opening in the outer housing to produce a hole in the construction material. Similarly, a gas compressor or a cartridge filled with compressed carbon dioxide can be operatively associated with the blast chamber. When the trigger mechanism is actuated, the compressed gas from the compressor or cartridge can be released into the blast chamber, thereby driving the internal piston as described above.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a pneumatic punch device in accordance with an exemplary embodiment of the invention;

FIG. 2 illustrates a cutaway view of the pneumatic punch device of FIG. 1;

FIG. 3A shows a perspective view of a triangular prism tip in accordance with an embodiment of the invention;

FIG. 3B shows a bottom view of the triangular prism tip of FIG. 3A;

FIG. 4A shows a perspective view of a conical tip in accordance with an embodiment of the invention;

FIG. 4B shows a bottom view of the conical tip of FIG. 4A;

FIG. 5A shows a perspective view of a pyramidal tip in accordance with an embodiment of the invention;

FIG. 5B shows a bottom view of the pyramidal tip of FIG. 5A;

FIG. 6A shows a perspective view of a cylindrical tip in accordance with an embodiment of the invention;

FIG. 6B shows a bottom view of the cylindrical tip of FIG. 6A; and

FIG. 7 illustrates an example of loading a container within the blast chamber of a pneumatic punch device in accordance with an embodiment of the invention.

### DETAILED DESCRIPTION OF THE PREFERRED EMBODIMENTS

The embodiments described herein extend to methods, devices, systems, assemblies, and apparatus for producing holes in construction materials, such as metal decking. Such methods, devices, systems, assemblies, and apparatus are configured to, for example, allow a single worker to quickly and accurately form a hole in a construction material without requiring excessive effort or physical force on the part of the worker.

Reference will now be made to the drawings to describe various aspects of exemplary embodiments of the invention. It is understood that the drawings are diagrammatic and schematic representations of such exemplary embodiments, and are not limiting of the present invention, nor are any particular elements to be considered essential for all embodiments or that elements be assembled or manufactured in any particular order or manner. No inference should, therefore, be drawn from the drawings as to the necessity of any element. In the following description, numerous specific details are set forth in order to provide a thorough understanding of the present invention. It will be obvious, however, to one of ordinary skill in the art that the present invention may be practiced without these specific details. In other cases, well known aspects of construction tools and general manufacturing techniques are not described in detail herein in order to avoid unnecessarily obscuring the novel aspects of the present invention.

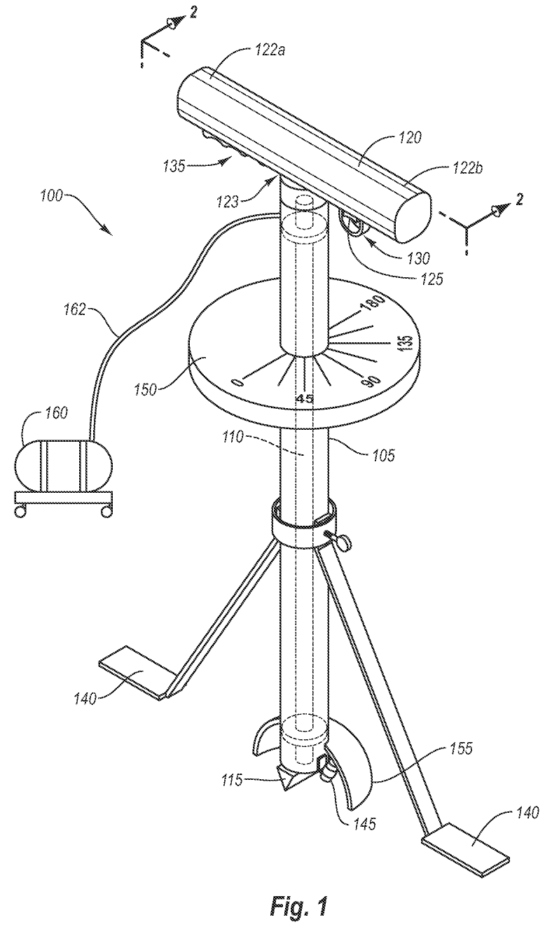

FIGS. 1-7 and the following discussion are intended to provide a brief general description of an exemplary pneumatic punch device which can be used according to aspects of the present invention to form holes in construction materials with minimal effort required of a construction worker. While a pneumatic punch device is described below with respect to forming holes in construction materials, this is but one single example, and embodiments of the invention may be utilized in other fields or for other purposes.

Throughout the application, the terms proximal and distal are used in the description of different ends of the device. Unless stated otherwise, the proximal end is towards the handle and the distal end is towards the tip. Additionally, the terms first and second are used in the description of different ends of the device. Unless stated otherwise, the first end corresponds to the proximal end and the second end refers to the distal end.

FIG. 1 illustrates a pneumatic punch device 100 in accordance with an embodiment of the invention. In at least one implementation, the punch device 100 is capable of punching a hole in a construction material. For example, the punch device 100 can be configured to punch through metal decking, metal beams, concrete, wood, drywall or any other material used in construction. In particular, the punch device 100 is configured to easily setup, produce a hole of the desired shape and size, and be moved to another location, as described below.

FIG. 1 shows that the pneumatic punch device 100 includes an outer housing 105. In at least one implementation, the outer housing 105 is approximately cylindrical in shape. In particular, the outer housing 105 can include a longitudinal axis that is, in the case of a cylindrical outer housing 105, an axis which is vertical and passes through the center of the outer housing 105 (as viewed in FIG. 1). Additionally or alternatively, the outer housing 105 can include an outer surface and an inner cavity. The inner cavity can include at least one opening through the outer surface, whereby access can be obtained to the inner cavity, as described below. Additionally or alternatively, the outer housing 105 can include a distal end that is near the construction material when the punch device 100 is in use, as stated above.

FIG. 1 also shows that the pneumatic punch device 100 includes an internal piston 110. In at least one implementation, the internal piston 110 is located at least partially within the internal cavity of the outer housing 105. For example, the internal piston 110 can be cylindrical in shape and can include a longitudinal axis that is generally parallel to, or collinear with, the longitudinal axis of the outer housing 105.

In at least one implementation, the internal piston 110 can be configured for reciprocal motion within the internal cavity and along the longitudinal axis of the internal piston 110. That is, the internal piston 110 can be configured to move back and forth within the internal cavity. Accordingly, the internal piston 110 can be driven through the internal cavity such that a portion of the internal piston 110 extends out of the opening in the outer housing 105 to produce a hole in the construction material. The internal piston 110 can then be partially or completely withdrawn back into the internal cavity, as discussed below.

FIG. 1 further shows that the punch device 100 can include a tip 115 connected to the internal piston 110. In at least one embodiment, the tip 115 is permanently attached to the internal piston 110, and the tip 115 and internal piston 110 must both be removed from the outer housing 105 if a new or different tip 115 is desired. Additionally or alternatively, the tip 115 can be removably attached to the internal piston 110, such that the tip 115 can be removed and a new tip 115 attached without removing the internal piston 110 from the internal cavity of the outer housing 105.

FIG. 1 also shows that the punch device 100 can include a handle 120. In at least one implementation, the handle 120 is coupled to the outer housing 105 and can be used to move or aim the punch device 100. For example, the handle 120 can include two arms 122a, 122b extending horizontally away from the outer housing 105 (as viewed in FIG. 1). The two arms 122a, 122b can be gripped in an operators hands when using the punch device 100. For example, the arms 122a, 122b of the handle 120 may contain finger grooves for added grip-strength, security, or comfort, or other means for assisting the grip of an operator, including a coating or cushion on the handle 120 such as rubber, foam, or the like.

In at lest one implementation, the arms 122a, 122b of the handle 120 may be relatively short in length, extending only far enough from a central post 123 for the operator to grip the handle 120. In particular, the arms 122a, 122b can be relatively short in length to provide access to areas, such as corners, where the operator has to operate in a relatively small area. Additionally or alternatively, the arms 122a, 122b of the handle 120 extending from the central post 123 may be longer. Longer arms 122a, 122b can provide greater stability or create a better grip for the operator.

In at least one implementation, the handle 120 can include a central post 123 extending distally from the handle 120 between the two arms 122a, 122b. In particular, the central post 123 can share a central longitudinal axis with the internal piston 110 and the outer housing 105. Additionally or alternatively, the central post 123 can be used to couple the handle 120 to the outer housing 105, to the internal piston 110, or both.

FIG. 1 further shows that the punch device 100 can include a trigger mechanism 125 for releasing a compressed gas, as discussed below. In particular, the trigger mechanism 125 may be attached to the handle 120. For example, the trigger mechanism 125 can be attached to one of the arms 122a, 122b of the handle 120. Additionally or alternatively, the trigger mechanism 125 can be attached to the central post 123 of the handle 120.

In at least one implementation, the trigger mechanism 125 can use a trigger mechanism 125 similar to trigger mechanisms used in firearms, as discussed below. Additionally or alternatively, the trigger mechanism 125 can include a button, a switch, a lever, a key or any other mechanism configured to release a compressed gas when activated by an operator. For example, the trigger mechanism 125 can include a button operably connected to an electronic device, such that the compressed gas is released into the blast chamber, as described below.

FIG. 1 also shows that the trigger mechanism 125 can be covered by a trigger guard 130. For example, the trigger mechanism 125 can be covered by a guard 130 that prevents the operator from activating the trigger mechanism 125 accidently. Additionally or alternatively, the trigger mechanism 125 may be covered by a cap that must be removed prior to operation.

FIG. 1 further shows that the punch device 100 can include a safety lever 135. In at least one implementation, the safety lever 135 is operably connected to the trigger mechanism 125 such that the trigger mechanism 125 cannot be activated unless the safety lever 135 is depressed. Additionally or alternatively, the safety lever 135 can be operably connected to the blast chamber such that activating the trigger mechanism 125 cannot release the compressed gas unless the safety lever 135 has been similarly activated.

In at least one implementation, the safety lever 135 can be attached to the handle 120. For example, the safety lever 135 can be attached to the arm 122a, 122b of the handle 120 opposite the trigger mechanism 125. Additionally or alternatively, the safety lever 135 can be attached to the same arm 122a, 122b of the handle 120 as the trigger mechanism 125. Alternatively, the safety lever 135 can be attached to the central post 123 of the handle 120. Further, the safety lever 135 can be attached to the one or more footholds 140, discussed below.

FIG. 1 also shows that the punch device 100 can include one or more footholds 140. In at least one implementation, the one or more footholds 140 are attached to the outer surface of the outer housing 105. In particular, the one or more footholds 140 can be used by an operator to ensure that the punch device 100 is stable during use. Additionally or alternatively, the one or more footholds 140 can be used to allow the weight of the operator to ensure that the punch device 100 remains close to the construction material during use. That is, an operator standing on the one or more footholds 140 can ensure that the punch device 100 does not recoil from the construction material during use.

In at least one implementation, the one or more footholds 140 are not permanently attached to the outer housing 105. For example, the one or more footholds 140 can be adjustable, such that their location and orientation relative to the outer housing 105 can be adjusted. Additionally or alternatively, the one or more footholds 140 can be removably attached to the outer housing 105, such that the one or more footholds 140 can be removed as desired by the user.

FIG. 1 further shows that the punch device 100 can include a guidance component 145. In at least one implementation, the guidance component 145 can provide a visual representation on the construction material where the tip 115 and the internal piston 110 will produce a hole. In particular, the guidance component 145 can include a laser, an LED, a light or any other visual representation. For example, the guidance component 145 can provide an “x”, a circle or a dot to show where the center of the tip 115 will come in contact with the construction material. Additionally or alternatively, the guidance component 145 can provide a visual representation of the outline of the hole that will be produced.

Also illustrated in FIG. 1 is a guard flap 155 near the distal end of device 100. Guard flap 155 can be selectively or permanently attached to the distal end of outer housing 105. As illustrated, guard flap 155 is, in the illustrated embodiment, generally concave and extends at least partially around outer housing 105. Guard flap 155 can provide additional protection to a user of device 100. For instance, guard flap 155 can at least partially enclose tip 115 so as to prevent an object from being inadvertently or undesirably placed under tip 115. Additionally, guard flap 155 can also prevent materials from projecting away from the area where a hole is being punched. For example, when tip 115 is driven into some construction materials, the construction materials may break apart and be projected into the air. Guard flap 155 can contain these materials to prevent them from injuring nearby people or objects. Guard flap 155 can be formed in any suitable matters. For instance, guard flap 155 can be formed of a metal, plastic, rubber, or the like.

In at least one implementation, the coupling between the handle 120 and the outer housing 105 can be a rigid attachment such that no movement is observed between the handle 120 and the outer housing 105. Additionally or alternatively, the handle 120 is able to disengage from the outer housing 105, which may be useful in depositing additional sources of compressed gas in the blast chamber 230, as discussed below. Additionally or alternatively, the coupling can be configured such that the handle 120 is able to rotate about the shared central axis at the interface relative to the outer housing 105. The rotation of the handle 120 relative to the outer housing 105 can provide rotation of the tip 115. The rotation of the handle 120 relative to the outer housing 105 can also provide a means of “cocking” the device, as described below.

FIG. 1 also shows that the punch device 100 can also include a measuring mechanism 150. In at least one implementation, the measuring mechanism 150 can include a disc or portion thereof attached to the outer housing 105 with markings designating different angles. The handle 120 can be attached to the internal piston 110 such that rotation of the handle 120 relative to the outer housing 105 rotates the internal piston 110 and the tip 115 relative to the outer housing 105. The disc attached to the outer housing 105 can indicate the amount the handle 120, and, therefore, the internal piston 110 and the tip 115, has rotated relative to the outer housing. Thus, the measuring mechanism 150 can enable accurate orientation of the tip 115 so that the hole created with the punch device 100 is oriented in a desired way. For instance, a hole created using punch device 100 may need to have a specific orientation relative to another hole, a wall, or a fixture. By rotating the handle 120 and measuring the degree of rotation using the measuring mechanism 150, the tip 115 can be oriented as desired so that the punch device 100 create a hole in a desired orientation.

Additionally or alternatively, the measuring mechanism 150 can include a window placed within the handle 120 with markings designating different angles such that as the central post 123 of the handle 120 is rotated, a component beneath the window remains stationary and the degree of rotation can be measured by viewing how far the window has moved in relation to the stationary component. Additionally or alternatively the measuring mechanism 150 can include a window placed on the outer housing 105 with markings designating varied angles such that as the internal piston 110 is rotated, a component of the internal piston 110 is viewable through the window to measure how far the internal piston 110 has rotated.

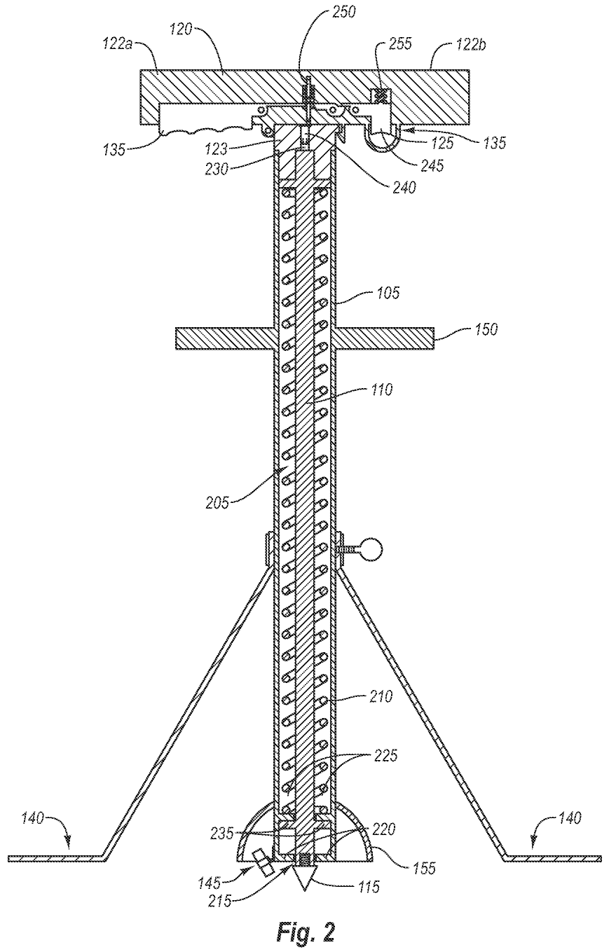

FIG. 2 illustrates a cutaway view of the pneumatic punch device 100 of FIG. 1 in accordance with an embodiment of the invention. FIG. 2 shows that the outer housing 105 can include an internal cavity 205 that can accommodate the internal piston 110, as described above. In at least one implementation, the punch device 100 includes a means for retracting 210 the internal piston 110 when the internal piston 110 is driven through an opening 215 in the outer housing 105. For example, the means for retracting 210 can include a spring around the internal piston 110, such that when the internal piston 110 is driven through the opening 215 in the outer housing 105, the spring provides resistance, preventing the internal piston 110 from completely exiting the internal cavity 205.

In at least one implementation, the means for retracting 210 the internal piston 110 can include a damping mechanism. In particular, damping is any effect that tends to reduce the amplitude of oscillations in a system which has the ability to oscillate. A system is considered critically damped if the system returns to equilibrium as quickly as possible without oscillating. A system is considered over damped if the system returns to equilibrium without oscillating, although the system returns to equilibrium more slowly than a critically damped system. The more the system is over damped, the slower the system returns to equilibrium. A system is considered under damped if the system oscillates with the amplitude gradually decreasing to zero.

FIG. 2 also shows that the outer housing 105 can include a first housing stop 220. In at least one implementation, the first housing stop 220 can be configured to prevent the internal piston 110 from exiting the internal cavity 205 when the punch device 100 is activated. For example, the first housing stop 220 can be located at or near the at least one opening 215 in the outer housing 105, such that when the internal piston 110 has been advanced a certain distance through the opening 215, the first housing stop 220 will provide resistance to further movement of the internal piston 110.

FIG. 2 further shows that the outer housing 105 can include a second housing stop 225. In at least one implementation, the second housing stop 225 can be longitudinally displaced within the internal cavity 205 a distance from the first housing stop 220. The second housing stop 225 can be configured to prevent the internal piston 110 from retracting into the internal cavity 205 more than desired. In particular, the second housing stop 225 can prevent the internal piston 110 from retracting further than desired and disrupting the fit between a blast chamber 230 and the internal piston 110, as discussed below.

FIG. 2 also shows that the internal piston 110 can include a first piston stop 235. In at least one implementation, the first piston stop 235 can be disposed between the first housing stop 220 and the second housing stop 225 such that the first piston stop 235 prevents excessive motion of the internal piston 110. For example, as the internal piston 110 is driven out of the internal cavity 205 during use, the first piston stop 235 can strike the first housing stop 220, preventing additional outward movement of the internal piston 110. Additionally or alternatively, as the internal piston 110 is retracted, the first piston stop 235 can strike the second housing stop 225, preventing additional inward movement of the internal piston 110.

FIG. 2 further shows that the punch device 100 includes a blast chamber 230. In at least one implementation, the blast chamber 230 focuses the force of releasing a compressed gas onto the internal piston 110. This force can, in turn, cause the internal piston 110 to move in a reciprocal manner out of the at least one opening 215 in the outer housing 105.

In at least one implementation, the compressed gas can be produced using a combustible or explosive material. A combustible material can include a material that is capable of burning or is otherwise involved in an exothermic process. An explosive material is a material that either is chemically or otherwise energetically unstable or produces a sudden expansion of the material usually accompanied by the production of heat and large changes in pressure upon initiation. An explosion can proceed through deflagration or through detonation. Deflagration includes subsonic combustion that propagates through thermal conductivity. That is, hot burning material heats the next layer of cold material and ignites it, propagating through the material. In contrast, detonation can include combustion in which a supersonic shock wave (or pressure wave) is propagated through a material. The shock compresses the material thus increasing the temperature of the material to the point of ignition. The ignited material burns behind the shock and releases energy that supports the shock propagation.

In at least one implementation, the compressed gas can be produced in the blast chamber 230 through the ignition of gunpowder or another propellant powder. In particular, a combustible powder can be placed directly within the blast chamber 230. Additionally or alternatively, the combustible material can be placed in a container 240 such as a bullet, a shell, a casing or any other suitable container which is configured to be contain a known amount of combustible material and placed within the blast chamber 230.

In at least one implementation, the container 240 can be stored within a storage device such as a clip, a round, a cartridge or any other device which is configured to store multiple containers 240. In particular, the storage device can be configured to load a second container 240 in the blast chamber 230 upon the removal of a first container 240. For example, the second container 240 can be placed in the blast chamber 230 through pump action, bolt action, lever action, a semi-automatic or an automatic action.

A pump-action includes a mechanism in which a handgrip or other pumping can be pumped back and forth in order to eject a spent container 240 and place a fresh one within the blast chamber 230. A bolt action includes a mechanism in which a bolt is operated manually to open and close the blast chamber 230. As the bolt is operated the blast chamber 230 is opened, the spent container 240 is withdrawn and ejected, and a new container 240 is placed into the blast chamber 230 and the bolt is closed. A lever-action includes a lever, which can be located around the trigger guard area or include the trigger guard 130 itself, that can be moved one direction to open the blast chamber 230 and eject a spent container 240. The lever can be subsequently moved back to its initial location to insert a new container 240 in the blast chamber 230 and close the blast chamber 230. A semi-automatic system includes a mechanism that uses the force of the deflagration or detonation to eject the spent container 240, load a new container 240 and prepare the trigger mechanism 125 to fire again when the trigger mechanism 125 is released and reactivated. In contrast, an automatic system is similar to a semi-automatic system, however, the trigger mechanism 125 does not need to be released and reactivated for subsequent firings.

FIG. 2 also shows that, the internal piston 110 includes a proximal end which fits tightly within or against the blast chamber 230. In at least one implementation, a tight fit between the internal piston 110 and the blast chamber 230 can prevent the compressed gas from escaping the blast chamber 230 without producing sufficient force on the internal piston 110 to force the internal piston 110 out of the at least one opening 215 in the outer housing 105. In particular, rings, washers or other devices can be used to facilitate a tight fit between the proximal end of the internal piston 110 and the blast chamber 230.

FIG. 2 further shows a more detailed view of the trigger mechanism 125. In at least one implementation, the trigger mechanism 125 can include a trigger 245. The trigger 245 can be operably connected to a firing pin 250 through a trigger spring 255 such that when the trigger 245 is actuated, the firing pin 250 is released. The firing pin 250, in turn can release a compressed gas into the blast chamber 230. For example, the firing pin 250 may strike a primer of a container 240, which includes a combustible powder, with sufficient force to cause the primer to detonate the combustible powder.

It will be appreciated that other drive mechanisms in addition to those described above can be used without departing from the scope of the present invention. For instance, the punch device 100 may be formed with, or attached to, a gas compressor 160 that compresses air or other gases. The compressed gas can be communicated from the gas compressor 160 to the blast chamber 230 via hosing 162. More specifically, when trigger mechanism 125 is actuated, a valve can be opened that allowed the compressed gas from gas compressor 160 to enter into the blast chamber 230. Introduction of the compressed gas into the blast chamber 230 can drive the internal piston 110 in a similar manner as described above.

In still other exemplary embodiments, compressed carbon dioxide (CO2) can be used to drive the internal piston 110. Compressed carbon dioxide can be stored in containers 240 that can be loaded into the blast chamber 230, or otherwise associated with blast chamber 230. When the trigger mechanism 125 is actuated, the container 240 can be punctured (e.g., with firing pin 250), thereby releasing the compressed carbon dioxide. The release of the compressed carbon dioxide can drive the internal piston 110 in order to form a hole in the construction material.

In light of the disclosure herein, it will be appreciated that the internal piston can be driven using any one of a number of pneumatic mechanisms. Furthermore, it will be understood that the above described mechanisms (e.g., combustible materials, a blast chamber, a compressed gas such as air and/or compress carbon dioxide, gas compressors, and the like) are each examples of means for driving the internal piston 110.

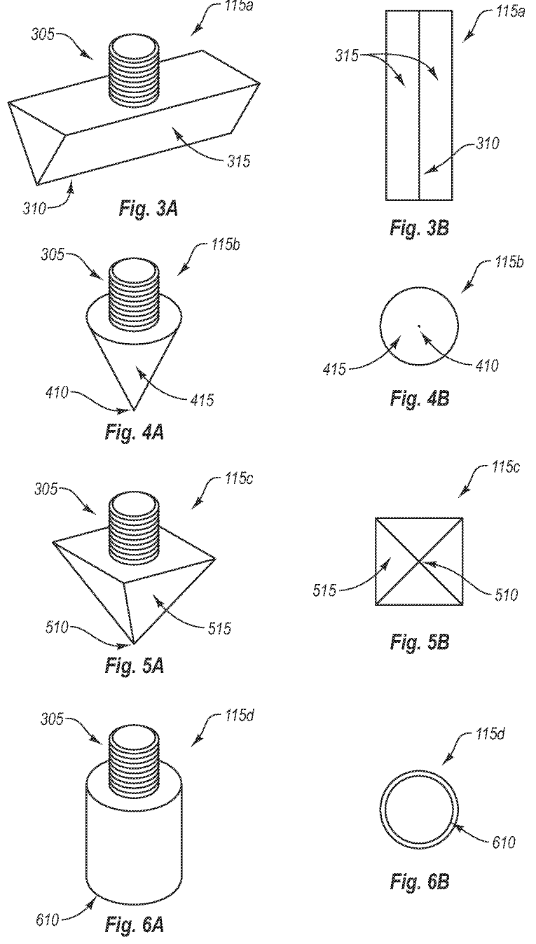

FIGS. 3A and 3B show perspective and bottom views, respectively, of a triangular prism tip 115a that can be attached to an internal piston 110, such as the internal piston 110 of FIGS. 1 and 2, in accordance with an embodiment of the invention. FIGS. 3A and 3B show that the tip 115a can include threading 305, or some other attachment mechanism, for releasably attaching the tip 115a to an internal piston 110. In at least one embodiment, the triangular prism tip 115a can include a narrow edge 310 which is configured to punch through the construction material. As the tip 115a continues into the construction material, the surface 315 of the tip 115a widens the hole in the construction material, producing a rectangular hole.

FIGS. 4A and 4B show perspective and bottom views, respectively, of a conical tip 115b that can be attached to an internal piston 110, such as the internal piston 110 of FIGS. 1 and 2, in accordance with an embodiment of the invention. FIGS. 4A and 4B show that the tip 115b can include threading 305, or some other attachment mechanism, for releasably attaching the tip 115b to an internal piston 110. In at least one embodiment, the conical tip 115b can include a narrow point 410 which is configured to punch through the construction material. As the tip 115b continues into the construction material, the surface 415 of the tip 115b widens the hole in the construction material, producing a circular hole.

FIGS. 5A and 5B show perspective and bottom views, respectively, of a pyramidal tip 115c that can be attached to an internal piston 110, such as the internal piston 110 of FIGS. 1 and 2, in accordance with an embodiment of the invention. FIGS. 5A and 5B show that the tip 115c can include threading 305, or some other attachment mechanism, for releasably attaching the tip 115c to an internal piston 110. In at least one embodiment, the pyramidal tip 115c can include a narrow point 510 which is configured to punch through the construction material. As the tip 115c continues into the construction material, the surface 515 of the tip 115c widens the hole in the construction material, producing a square shaped hole.

FIGS. 6A and 6B show perspective and bottom views, respectively, of a cylindrical tip 115d that can be attached to an internal piston 110, such as the internal piston 110 of FIGS. 1 and 2, in accordance with an embodiment of the invention. FIGS. 6A and 6B show that the tip 115d can include threading 305, or some other attachment mechanism, for releasably attaching the tip 115d to an internal piston 110. In at least one embodiment, the cylindrical tip 115d can include a narrow edge 610 which is configured to punch through the construction material.

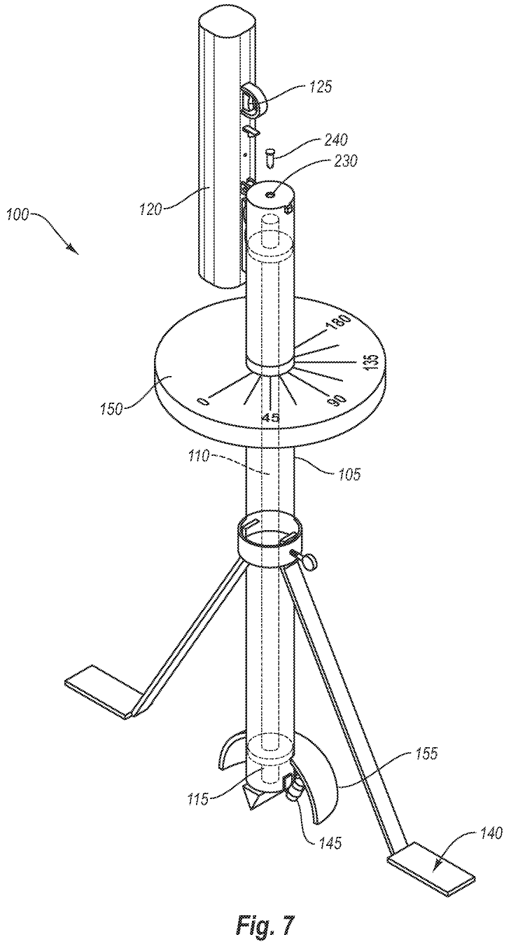

FIG. 7 illustrates an example of loading a container 240 within the blast chamber 230 of a pneumatic punch device 100 in accordance with an embodiment of the invention. As described above, the container 240 can hold a combustible material or a compressed gas. In at least one implementation, the handle 120 can be at least partially disengaged from the outer housing 105 to allow access to the blast chamber 230 and removal of the container 240. The handle 120 can then be reengaged to the outer housing 105, such that the punch device 100 is ready for additional use.

Additionally or alternatively, a cocking action can be used in combination with a pump-action, bolt-action or lever-action to remove a spent container 240 from the blast chamber 230 and load an additional container 240. For example, the cocking action can be provided by rotating the handle 120 relative to the outer housing 105. As the handle 120 is rotated in one direction, the spent container 240 is removed from the blast chamber 230. As the handle 120 is rotated back to the original position a fresh container 240 from the clip, round, or cartridge is deposited within the blast chamber 230. Additionally or alternatively, an external lever or bolt can be operably attached to the blast chamber 230 to allow the removal of the spent container 240 and the deposit of another container 240 into the blast chamber 230.

The present invention is described in terms of using the device in the context of metal decking; however, it will be appreciated that the present invention can be used in a variety of situations to punch holes in a variety of materials. For example, the device can be used to punch holes in wood flooring, concrete, other sheets of metal, and the like. Further, the device has been described as punching a hole in construction material with a single use of the device; however, it is within the scope of the device to be used in scenarios in which multiple uses of the device may be required to punch a hole in construction material.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device for producing holes in a construction material, the device comprising:
an outer housing including:
an internal cavity;
at least one opening; and
a distal end configured to be near the construction material during use;
an internal piston that includes a tip, wherein the internal piston is received within the internal cavity and is configured for reciprocal motion within the outer housing;
a handle coupled to the outer housing;
a trigger mechanism configured to release pressurized gas; and
a blast chamber, wherein the pressurized gas is released into the blast chamber to drive the internal piston through the opening in the outer housing and produce a hole in the construction material.

2. The device of claim 1, further comprising a first foothold and a second foothold, wherein the first foothold and the second foothold are externally attached to the outer housing adjacent to the distal end of the outer housing and that extend away from the outer housing.

3. The device of claim 2, wherein the first and second footholds are one of:
removably attached, wherein the outer housing comprises means to attach the first and second footholds at multiple heights along the length of the outer housing; or
movably attached to the outer housing.

4. The device of claim 1, wherein the pressurized gas is i) produced using a combustible material; ii) is communicated into the blast chamber from a gas compressor; or iii) is stored in a container within the blast chamber.

5. The device of claim 4, wherein the combustible material is housed within a container comprising one of a bullet, a shell, or a casing.

6. The device of claim 5, wherein the container storing the combustible material or the pressurized gas is stored within one of a clip, round, or cartridge, such that the device may be used multiple times with only a single clip, round, or cartridge being loaded in the device, and wherein when a first container is spent by using the device, the first container is removed and a second container is deposited in the blast chamber by one of:
pump-action;
bolt-action;
lever-action;
a semi-automatic system; or
an automatic system.

7. The device of claim 4, wherein the trigger mechanism comprises a trigger and a valve, wherein the trigger is operably connected to the valve such that when the trigger is actuated the valve is opened, thereby allowing compressed gas from the gas compressor to enter the blast chamber.

8. A device for punching holes in a construction material, the device comprising:
an outer housing including:
an internal cavity; and
at least one opening;
an internal piston including a tip and wherein the internal piston is received within the internal cavity of the outer housing, and wherein the internal piston includes a longitudinal axis which is substantially parallel to a longitudinal axis of the outer housing;
means for retracting the internal piston;
means for regulating the motion of the internal piston within a desired range;
a handle coupled to the outer housing; and
means for driving the internal piston.

9. The device of claim 8, wherein the means for regulating the motion of the internal piston comprises:
a first housing stop disposed within the internal cavity near the at least one opening of the outer housing; and
a second housing stop longitudinally displaced within the internal cavity from the first housing stop.

10. The device of claim 9, wherein the means for regulating the motion of the internal piston further comprises a first piston stop, wherein the first piston stop is disposed between the first housing stop and second housing stop to work cooperatively with the first housing stop and second housing stop to regulate the motion of the internal piston.

11. The device of claim 8, wherein the means for driving the internal piston comprises combustible powder deposited within a blast chamber, wherein actuation of a trigger mechanism detonates the combustible powder, thereby driving the internal piston.

12. The device of claim 8, wherein the means for driving the internal piston comprises a compressed gas from a gas compressor or a container configured to stored compressed gas.

13. The device of claim 8, wherein releasing the compressed gas from the gas compressor or container drives the internal piston.

14. A device for producing holes in construction material, the device comprising:
an outer housing including:
an internal cavity;
at least one opening;
a first housing stop; and
a second housing stop;
an internal piston housed within the internal cavity and configured for reciprocal motion within the outer housing, wherein the internal piston includes:
a first end;
a second end opposite the first end, wherein the second end includes a tip; and
a first piston stop;
means for retracting the internal piston, wherein the means for retracting a piston retracts the internal piston through the opening into the internal cavity, and wherein the first piston stop is disposed between the first housing stop and second housing stop to work cooperatively with the first housing stop and second housing stop to regulate the reciprocal motion of the internal piston;
a handle coupled to the outer housing;
a trigger mechanism attached to the handle;
a blast chamber, wherein the first end of the internal piston is seated within the blast chamber and is able to move reciprocally within the blast chamber; and
a driving mechanism that can be actuated by the trigger mechanism to drive the internal piston through the opening in the outer housing to produce a hole in the construction material.

15. The device of claim 14, wherein the driving mechanism comprises one or more cartridges containing compress carbon dioxide, wherein the compress carbon dioxide is released within the blast chamber when the trigger mechanism is actuated.

16. The device of claim 14, wherein the driving mechanism comprises a compressor adapted to compress a gas and communicate the compressed gas into the blast chamber when the trigger mechanism is activated so as to drive the internal piston.

17. The device of claim 14, wherein the internal piston further comprises a second piston stop, and wherein the means for retracting a piston is a spring that is compressed between the second housing stop and the second piston stop.

18. The device of claim 14, further comprising a guidance component that provides visual representation on the construction material where the internal piston will be producing a hole.

19. The device of claim 18, wherein the guidance component comprises a laser, an LED, or a light.

20. The device of claim 14, further comprising a safety lever attached to the handle and configured to prevent the driving mechanism om being actuated unless the safety lever is engaged, wherein the safety lever is operably connected to one of the trigger mechanism or the blast chamber.

21. The device claim 14, wherein the handle rotates relative to the outer housing at an interface between the handle and the outer housing and wherein the handle interfaces with the internal piston such that when the handle rotates relative to the outer housing, the tip rotates an equivalent amount relative to the outer housing.

22. The device of claim 21, further comprising a measuring mechanism configured to measure the number of degrees the handle rotates relative to the outer housing.

23. The device of claim 22, wherein measuring mechanism is one of:
a disc or portion thereof attached to the outer housing with markings designating different angles;
a window placed within the handle with markings designating different angles such that as the central post of the handle is rotated, a component beneath the window remains stationary and the degree of rotation can be measured by viewing how far the window has moved in relation to the stationary component; or
a window placed on the outer housing with markings designating varied angles such that as the internal piston is rotated, a component of the internal piston is viewable through the window to measure how far the central post of the handle has rotated.

24. The device of claim 14, wherein the tip of the internal piston at the second end is removably attached.

25. The device of claim 24, wherein the removable tip is shaped as one of:
a triangular prism;
a cone;
a pyramid; or
a cylinder.
